(19) United States
(12) Patent Application Publication
(10) Pub. No.: US 2007/0134145 A1
(43) Pub. Date: Jun. 14, 2007

(54) Precious metal catalyst stabilized with iron oxide for the removal of pollutants from exhaust gases from leanburn engines

(76) Inventors: Wolfgang Strehlau, Dossenheim (DE); Olga Gerlach, Ludwigshafen (DE)

Correspondence Address: PATENT GROUP 2N;JONES DAY, NORTH POINT, 901 LAKESIDE AVENUE, CLEVELAND, OH, 44114, US

(21) Appl. No.: 10/588,429

(22) PCT Filed: Feb. 3, 2005
(86) PCT No.: PCT/EP05/01090

§ 371 Date: Sep. 18, 2006

(30) Foreign Application Priority Data
Feb. 6, 2004 (DE) 10 2004 005 997.7

(51) Int. Cl. B01D 53/94

(52) U.S. Cl. 423/213.5; 502/326

(57) ABSTRACT

Catalyst for exhaust-gas purification in lean-burn engines, characterized in that the catalyst comprises at least the following components: (i) iron oxide, (ii) platinum or rhodium or a mixture of platinum and rhodium as active metal, (iii) a support oxide, the support oxide containing zirconium oxide, cerium/zirconium mixed oxide or mixtures of these compounds if the active metal used is platinum alone, or the support oxide containing zirconium oxide, cerium/zirconium mixed oxide, aluminium oxide, aluminosilicate, silicon oxide, zeolite or mixtures of these compounds if the active metal used is rhodium or a mixture of platinum and rhodium.

The present invention relates to a novel catalyst for removing pollutants from the exhaust gases from lean-burn engines, the catalyst, by being doped with iron oxide, acquiring a considerably higher thermal stability than corresponding catalysts of the prior art. In addition to iron oxide, the catalyst contains active metal in the form of the precious metals platinum or rhodium or a mixture thereof. Iron oxide and active metal are in this case on a support material which, depending on the preferred application, contains zirconium oxide, cerium/zirconium mixed oxide, aluminium oxide, aluminosilicate and zeolite or mixtures thereof. Rare earth oxides and the oxides of gallium or indium can be used as promoting components. The invention also relates to a process for producing the catalyst and to a method for purifying exhaust gases from lean-burn engines in rich/lean and constant lean mode using the catalyst according to the invention.

The main pollutants from the exhaust gas from lean-burn engines are carbon monoxide (CO), unburnt hydrocarbons (HC)—paraffins, olefins, aldehydes, aromatics—and nitrogen oxides (NOₓ), sulphur dioxide (SO₂), and also, in the case of diesel engines, particulates, which contain the carbon both as a solid and in the form of what is known as the “volatile organic fraction” (VOF). Depending on the operating point, the oxygen concentration in the diesel exhaust gas is mainly between 1.5 and 15%.

Compared to exhaust gases from petrol engines, diesel exhaust gases are at significantly lower exhaust-gas temperatures. For part-load operation, the exhaust-gas temperatures upstream of the catalyst are in the range between 120 and 300° C., and the maximum temperatures in full-load operation often reach more than 600° C. In particular for the purification of diesel exhaust gases from passenger cars, a high low-temperature activity is required of the oxidation and deNOₓ catalysts; on the other hand, they have to be highly thermally stable, in order to avoid a loss of activity at high temperatures, such as for example those which occur at full-load operation.

Currently, diesel passenger cars and lorries, although the latter only to a lesser extent, are equipped with precious metal-containing oxidation catalysts which are able to convert CO and HC, and also to a very slight extent particulates, into CO₂ and water. The NOₓ emissions are scarcely abated, on account of the high excess of oxygen in the exhaust gas.

DE 102 09 529.9 gives a description of catalyst technology used for the catalytic conversion of CO and HC for diesel engines (diesel oxidation catalysis).

EP 1 129 764 A1 describes a diesel oxidation catalyst consisting of Al₂O₃/SiO₂, zeolite and platinum, which after thermal ageing has a light-off temperature (T₅₀) for CO at 183° C. and for HC at 197° C. The NOₓ activity of this catalyst is very low.

U.S. Pat. No. 6,274,107 describes a catalyst which consists of a mixture of cerium oxide, iron-exchanged beta-zeolite and platinum or palladium and which is used for the oxidation of CO and HC in exhaust gases from diesel engines. The zeolite is used to adsorb hydrocarbons contained in the exhaust gas.

Pt/Fe/Al₂O₃ catalysts have been tested for stoichiometric and lean-burn engine applications by Y. Sakamoto (Applied Catalysis B: Environmental 23 (1999) 159-167). The measured light-off temperatures for HC (T_{50(HC)}) were very high, however, at approximately 290° C., and consequently in practice these catalysts are not suitable for use in diesel cars.

Reference is made to DE 102 09 529.9, in the name of the present Applicant, and the prior art cited therein for an overview of NOₓ catalysis in very general terms together with references to the most usual exhaust-gas catalysts and the relevant prior art relating to NOₓ storage catalysts. That document also provides an in-depth analysis of the problems of exhaust-gas catalysts of this type.

U.S. Pat. No. 6,265,342 claims a catalyst for the aftertreatment of diesel exhaust gases, which is composed of a catalytic double layer. The first layer consists of an iron-doped zirconium oxide, optionally also in combination with palladium, while the second layer is composed of a copper-doped zirconium oxide also containing platinum and tin. The light-off temperatures for the formation of CO₂ from CO and HC and for the conversion of NOₓ are over 200° C. Maximum NOₓ conversion rates of approximately 25% are achieved.

DE 198 36 249 relates to a method for breaking down nitrogen oxides in the exhaust gas from a combustion device, in which the combustion device is alternately operated in lean and rich operating phases, which is characterized in that in the lean operating phases the nitrogen oxides are broken down by means of a direct catalytic splitting reaction which is material-catalyzed by a splitting catalyst which is regenerated during the rich operating phases. The only indication as to the composition of the catalyst that can be used with success as part of a method of this type is that the splitting catalyst material used therein contains bismuth.

EP 0 722 763 relates to an adsorption agent for NOₓ, in which the oxides of Ru and/or Ce used as adsorbing components are applied to a titanium oxide support material. The titanium oxide support material is obtained by adding a manganese compound to amorphous titanium dioxide, and then heating the latter.

DE 100 36 886 describes an NOₓ storage catalyst which is free of alkali metals and rare earths, contains rhodium or a mixture of platinum and rhodium as active component(s) and has a very good low-temperature activity in the fresh state. No details are given as to the durability of the catalyst.

EP 1 036 591 describes an NOₓ storage catalyst which contains at least one element selected from the group consisting of alkaline-earth metals, alkali metals or rare earths and at least one precious metal, Pt, on a first support material. Rh is deposited on zirconium oxide as second support material. It is explained that the Rh/ZrO₂ has a high activity for the water/steam reforming and protects the catalyst from SOₓ poisoning.

EP 1 010 454 describes a storage catalyst which contains a zirconium oxide/alkali metal oxide composite and at least one precious metal selected from Pt, Pd, Rh.

WO 02/22255 presents NOₓ catalysts which contain at least one precious metal selected from rhodium and palladium and/or mixtures thereof, zirconium oxide and either cerium oxide, praseodymium oxide, neodymium oxide or mixtures thereof. The catalysts may have layer structures, with the upper layer being composed mainly of the abovementioned elements and the lower layer including a support oxide consisting of aluminium oxide, silicon oxide, silicon/aluminium oxide, zeolite or mixtures thereof, as well as platinum, palladium, rhodium or mixtures thereof.

Despite the large number of existing solution approaches aimed at optimizing catalysts which are suitable for removing pollutants from combustion engines, many problems which are of particular importance to the specialist field still remain. In particular, the ageing resistance of catalysts and their resistance to deactivation by sulphur compounds need to be improved. This applies in particular to catalysts which are used for purifying the exhaust gas from fuel engines operating in the non-stoichiometric range. By way of example, engines which are preferably run in the lean-burn mode, i.e. with an excess of oxygen, which are considered a type of engine that is particularly promising for the future, are based on an operating mode of this type.

In view of the prior art, one object of the invention was to provide a new class of catalysts for use with internal combustion engines, in particular for removing pollutants from exhaust gases from lean-burn engines, which either oxidize CO and HC to give CO₂ and water under a continuous lean-burn mode (diesel oxidation catalyst) or in addition to the oxidation of CO and HC can also reduce NOₓ (three-way catalyst) to produce harmless nitrogen (N₂). Under these conditions, the NOₓ reduction requires the engine to operate under rich/lean conditions and makes use of chemical sequences which can be described by the terms “NOₓ storage and reduction” or “NOₓ decomposition”. In this context, it should be ensured that in particular the decrease in the activity as diesel oxidation catalyst or three-way catalyst which occurs during the thermal ageing of both diesel oxidation catalysts and NOₓ storage and decomposition catalysts of the prior art is minimized. At the same time, the efficiency of the catalysts is to be increased further compared to the catalysts described in the prior art.

This object according to the invention is achieved by the provision of a novel catalyst generation for exhaust-gas purification in lean-burn engines, characterized in that the catalyst comprises at least the following components (i), (ii) and (iii):
(i) iron oxide,
(ii) platinum or rhodium or a mixture of platinum and rhodium as active metal,
(iii) a support oxide,
   the support oxide containing zirconium oxide, cerium/zirconium mixed oxide or mixtures of these compounds if the active metal used is platinum alone, or the support oxide containing zirconium oxide, cerium/zirconium mixed oxide, aluminium oxide, aluminosilicate, silicon oxide, zeolite or mixtures of these compounds if the active metal used is rhodium or a mixture of platinum and rhodium.

The catalyst is highly thermally stable. Its activity remains the same or drops only slightly even after thermal ageing at 700° C. in air. It therefore has a high activity combined, at the same time, with a high thermal stability. This is extremely advantageous when the catalyst is to be used in methods for removing pollutants from lean-burn engines.

Depending on its specific formulation, the catalyst according to the invention is suitable for use
a) as a diesel oxidation catalyst for the removal of carbon monoxide (CO) and hydrocarbons (HC),
b) for the removal of nitrogen oxides (NOₓ) in cyclically rich/lean mode, and
c) both for removing CO and HC and for removing NOₓ in cyclically rich/lean mode.

Furthermore, the present invention also relates to a process for producing the catalyst, to its use for removing pollutants from exhaust gases from lean-burn engines and to a method for purifying the exhaust gas from lean-burn engines operated in rich/lean and constant lean mode using the catalyst.

The following text is intended to define relevant terms which are of importance to understanding and interpreting the present invention.

In the context of the present invention, the generic terms “iron oxides”, “rare earth oxides” encompass in a very general way not only the stoichiometric oxides, but also the corresponding nitrates, sulphates, carbonates, hydroxides, suboxides, mixed oxides, ionic species and any desired mixtures of at least two of the abovementioned substances. Furthermore, all metals mentioned as elements also encompass the corresponding oxides and suboxides of iron, rare earth and their mixed oxide/oxide mixtures and mixed oxide/oxide mixtures with other elements.

“Precious metals” in the context of the present invention encompass the platinum metals, rhodium and platinum and are also referred to as active metals in the context of the present patent.

Combustion engines are thermal energy converters which transform chemical energy stored in fuels into heat by combustion and ultimately into mechanical energy.

For internal combustion engines, the air enclosed in a gastight and variable working space (e.g. a piston) is the working medium defined in the sense of a heat engine and is at the same time the carrier of the oxygen required for the combustion. The combustion is carried out cyclically, with both the fuel and the (atmospheric) oxygen being freshly charged before each cycle. Depending on the cycle used, for example described by a Carnot pV diagram, it is possible to draw an exact thermodynamic distinction between a spark-ignition engine and a diesel engine. A practical working definition of these types of engine is given below.

A significant criterion for classifying both types of engine and catalysts is the petrol to air ratio, expressed by means of the “air/fuel ratio” λ. In this context, a value of λ=1.0 corresponds precisely to the stoichiometric ratio of petrol to dry air, i.e. there is just enough air in the combustion chamber for it to be possible for all the petrol to be burnt stoichiometrically to form carbon dioxide and water. The specialist technical literature refers to mixtures with λ>1 as “lean” (excess oxygen) and those with λ<1 as “rich” (lack of oxygen). In the context of the present invention, mixtures with λ>1.2 are to be referred to as “lean” and mixtures with λ<1.0 are to be referred to as “rich”, in order to provide a clear demarcation from the stoichiometric range. Accordingly, the rich and/or lean mixtures defined in this way are also referred to as non-stoichiometric mixtures in the context of the present invention.

Conventional spark-ignition engines are characterized by the formation of a homogeneous petrol/air mixture outside the working space, i.e. the piston space, in which the combustion takes place, and by controlled externally generated ignition. Spark-ignition engines require low-boiling fuels which are not readily ignitable (the ignition limits for a spark-ignition engine are typically between λ=0.6 and λ=1.4). In the context of the present invention, it is of particular importance with regard to exhaust-gas catalysis that conventional spark-ignition engines which have a three-way catalyst controlled by x sensor are predominantly operated at a λ value of approximately 1 (=stoichiometric operation).

The term “lean-burn engines” is to be understood as meaning spark-ignition engines which are operated mainly with an excess of oxygen. For the purposes of the present invention, lean-burn engines are defined very specifically on the basis of their λ value, i.e. lean-burn engines in the context of the present invention are engines which, even apart from overrun cutoffs, are at least in part operated in the lean state, i.e. at a λ value of 1.2 or above. In addition, rich operating states may, of course, also occur in lean-burn engines: brief richer running of the engine and therefore also of the exhaust gases can be initiated by the engine electronics with the aid of modern injection systems or can also occur in natural driving operation (e.g. in the event of increased loads, at full load or when starting up). An alternating operating mode comprising rich and lean cycles is referred to in the context of the present invention as “rich-lean mode”.

In particular, lean-burn engines in the context of the invention are to be understood in very general terms as encompassing the following embodiments:
all spark-ignition engines with direct injection (DI engines) and with operating states of λ>1, and all spark-ignition engines with external mixture formation. This class includes, inter alia, stratified charge engines, i.e. engines which have an ignitable mixture in the vicinity of the spark plug but otherwise an overall lean mixture, and also spark-ignition engines with higher compression in conjunction with direct injection. This includes, for example, engines operating using the Mitsubishi method (GDI=gasoline direct injection; common rail injection), the FSI (=fuel stratified injection) engine developed by VW or the IDE (=injection directe essence) engine designed by Renault;
all diesel engines (see below);
multifuel engines, i.e. engines which burn fuels and fuel mixtures which are readily ignitable and/or not readily ignitable, such as alcohols, bio-alcohols, vegetable oils, kerosene, petrol and any desired mixtures of two or more of the abovementioned substances.

Diesel engines are characterized by internal mixture formation, a heterogeneous fuel/air mixture and by compression ignition. Accordingly, diesel engines require readily ignitable fuels. In the context of the present invention, it is particularly important that diesel exhaust gases have similar characteristics to the exhaust gases from lean-burn engines, i.e. are continuously lean, that is to say oxygen-rich. Consequently, the demands imposed on the catalysts for NOₓ reduction in combination with diesel engines, with regard to the elimination of nitrogen oxides, are similar to those imposed on catalysts used for spark-ignition engines in lean-burn mode. One significant difference between diesel passenger car engines and spark-ignition passenger car engines, however, is the generally lower exhaust-gas temperatures of diesel passenger car engines (100° C. to 350° C.) compared to spark-ignition passenger car engines (250° C. to 650° C.) which occur during the legally prescribed driving cycles. A lower exhaust-gas temperature makes the use of catalysts which are not contaminated with sulphates or are only slightly contaminated with sulphates particularly attractive, since desulphurization, as mentioned above, is only effectively possible at exhaust-gas temperatures above approximately 600° C. All the statements which have been made in the present invention with regard to catalysts for lean-burn engines therefore also apply in a corresponding way to catalysts which are used for diesel engines.

Depending on the mixture formation and the load/engine speed characteristic diagram, catalysts which are specifically matched to different engines are required for exhaust-gas treatment. For example, a catalyst for a conventional spark-ignition engine, the petrol/air mixture of which is continuously set to λ≈1 with the aid of injection and throttle valve and whose air/fuel ratio is optionally monitored with the aid of a λ sensor requires altogether different functionalities for the reduction of NOₓ than for example, a catalyst for a lean-burn engine which is operated at λ>1.2, i.e. has excess oxygen during normal driving operation. It is clear that catalytic reduction of NOₓ at an active metal is more difficult if there is an excess of oxygen.

The term “diesel oxidation catalyst”, as used in the context of the present invention, relates in very general terms to catalysts which remove two main pollutants from the exhaust gas from combustion engines, namely carbon monoxide by oxidation to form carbon dioxide and hydrocarbons by oxidation to form, ideally, water and carbon dioxide. If a catalyst is used in diesel engines, a third role may be performed in addition to the two roles mentioned above, namely the removal of particulates by oxidation.

The term “three-way catalyst”, as used in the context of the present invention, relates in very general terms to catalysts which remove three main pollutants from the exhaust gas of combustion engines, namely nitrogen oxides (NOₓ) by reduction to form nitrogen, carbon monoxide by oxidation to form carbon dioxide and hydrocarbons by oxidation to form, ideally, water and carbon dioxide. If a catalyst is used in diesel engines, a fourth role may occur in addition to the three mentioned above, namely the removal of particulates by oxidation.

Conventional three-way catalysts for spark-ignition engines according to the prior art are used in stoichiometric mode, i.e. at λ values which fluctuate within a narrow range around 1.0. The λ value is in this case set by regulating the petrol/air mixture in the combustion chamber with the aid of injector and throttle valve. In non-stoichiometric operation, i.e. in non-conventional operation, it is possible for λ values to deviate significantly from 1.0, for example λ>1.2 or λ>2.0, or alternatively λ<0.9. The discontinuous operation of an engine, i.e. alternating operation between lean and rich operating modes of the engine, is referred to as rich-lean mode.

One particular embodiment of a three-way catalyst which can also be operated in non-stoichiometric operation, in particular when lean operating states occur, is the NOₓ storage catalyst. In the context of the present invention, an NOₓ storage catalyst is to be understood as meaning a three-way catalyst which can operate in rich-lean mode and the composition of which means that the nitrogen oxides NOₓ, during lean-burn mode, are stored in a storage medium, typically a basic alkali metal oxide or alkaline-earth metal oxide, and the actual decomposition of the stored nitrogen oxides to form nitrogen and oxygen only takes place during a richer phase under reducing exhaust-gas conditions.

Conventional diesel oxidation catalysts are as far as possible operated with an excess of atmospheric oxygen, i.e. at λ values of >1. The air/fuel ratio is controlled quantitatively depending on the engine power required.

The embodiment of a diesel oxidation catalyst which corresponds to the prior art is based on the use of a refractory oxide on which platinum is deposited. A thermally stable zeolite is often admixed in order to prevent HC from breaking through, in particular in the cold-start phase.

The catalyst disclosed in the present invention and its use in methods for removing pollutants from exhaust gases from lean-burn engines are designed for long-term use in practice for the treatment of exhaust gases from motor vehicles. Accordingly, in the context of the present invention, the term “normal driving operation” is to be understood as meaning all exhaust gas compositions and temperatures which are typical of the operating points of an engine during the NEDC (New European Driving Cycle). In particular, the starting of the engine, the warming-up phase and operation under extreme loads are not to be regarded as being covered by normal driving operation.

The catalyst according to the invention is produced using a process which comprises bringing the iron oxide (i) or an iron compound from which the said iron oxide is formed through a heat treatment into contact with the active metal (ii) and the support oxide (iii).

The iron oxide is preferably applied to the support oxide by contacting the support oxide with a salt of iron, such as for example iron acetate or iron nitrate, which is preferably dissolved in a liquid. In a subsequent step, the iron salt is decomposed by a heat treatment involving an increase in the temperature and is thereby converted into iron oxide.

It is optionally also possible to use other processes to apply the iron oxide. Examples which may be mentioned here include the precipitation of iron compounds or iron or iron oxide nanoparticles by means of precipitating agents from aqueous or organic solution, or the vapour deposition of iron precursors, such as iron carbonyls.

Suitable iron compounds which can be used to apply the iron oxide include, for example, salt-like compounds, nanoparticles or organometal compounds.

The precious metal component may in principle be applied to the support oxide prior to the iron compound being added, together with the iron compound or after the iron compound has been added.

For the catalyst according to the invention, it is of crucial importance for the iron oxide which is present on the support oxide together with the precious metal preferably to be amorphous and/or for the iron oxide particles to be so small that the available X-ray diffractography technique does not find any reflections which can be assigned to the iron oxide. As can be seen from the diffractogram examples, it is possible to detect an increase in the base from 20°2θ to 40°2θ.

Examples which may be mentioned as possible processes for applying the precious metal component include impregnation, precipitation or vapour deposition. Possible precious metal compounds which may be used may, for example, be in salt form, complex compounds or of organometallic nature.

The loading of a zeolite with iron oxide and active metal can lead to ion exchange in the zeolite. The ion exchange is something with which the person skilled in the art is familiar and can be realized, for example, in aqueous medium or by means of solid-state reactions.

In both cases, the cations which were originally present in the zeolite are completely or partially displaced by the active metal, for example rhodium. In the case of an impregnation method, an active metal precursor dissolved in a generally aqueous medium, for example a rhodium precursor, is applied to the zeolite.

It should be noted that technologies which are customarily used in catalyst production for exhaust-gas catalysts, such as for example the mixing or blending of supported, different active metals which are in powder form or in the form of a slurry, the layered build-up of catalytically active substances within a washcoat or the combination of different catalyst zones within a monolithic catalyst bed are included in the scope of the process according to the invention.

It should be noted that certain applications of the catalyst according to the invention, e.g. for the removal of particulates which are present in the exhaust gas from diesel engines, require the addition of further iron components in the form of what is known as “bulk iron oxide”, in which iron oxide is present in the form of relatively large particles that are crystalline under X-ray analysis. However, an iron oxide of this type which is additionally present is expressly excluded from the statements made above, namely the need for the iron oxide that is present in the precious metal/support oxide/iron oxide composite described above to be amorphous under X-ray analysis.

The precious metal (active metal) is either platinum or rhodium or a mixture thereof.

The platinum/iron oxide combination according to the invention, in conjunction with zirconium oxide or cerium/zirconium mixed oxide or mixtures of these oxides as support oxide, gives good results in exhaust-gas catalysis. The rhodium/iron oxide or platinum/rhodium/iron oxide combinations according to the invention also give good results in exhaust-gas catalysis when used in conjunction with zirconium oxide, cerium/zirconium mixed oxide, aluminosilicate, aluminium oxide, silicon oxide, zeolite or mixtures of these compounds as support oxide.

It is surprising that with a view to removing pollutants from exhaust gases from lean-burn engines, it is preferable for the iron oxide that is present in the catalyst to be amorphous under X-ray analysis, i.e. for there to be no characteristic reflections of iron oxides or other iron-containing compounds, and that the catalyst only gives its optimum effect if the active metals used are matched to the support oxides or mixtures thereof that are to be used in the manner disclosed.

In the context of the present invention, with regard to the mass ratio, based on metallic elements, of iron oxide to the total precious metals, it is preferable to use an iron/precious metal ratio in a range between 0.5:1 and 15:1. A range between 1:1 and 10:1 is more preferred and a range between 1.5:1 and 8:1 is particularly preferred.

With regard to the weight ratio of precious metal, i.e. the total of platinum or rhodium or platinum and rhodium, to the support material, a proportion of 0.01% by weight to 6% by weight of precious metal, based on the total weight of precious metal and support material, is preferred, with a proportion by weight of 0.1% by weight to 4% by weight being particularly preferred.

Furthermore, the catalyst according to the invention may contain at least one further metal oxide in the form of rare earth oxides, gallium oxide or indium oxide, with at least some of these metal oxides being present in the precious metal/iron oxide/support oxide composite described above.

In the context of the present document, the terms “rare earth oxide”, “gallium oxide” and “indium oxide” also encompass the corresponding suboxides, mixed oxides and ionic species. The rare earth oxides include the oxides of La, Ce, Pr, Nd, Sm, Eu, Gd, Tb, Dy, Ho, Er, Tm, Yb, Lu and mixtures thereof.

In the context of the present document, rare earth oxide, gallium oxide and indium oxide are also referred to jointly by the term “promoters”.

The molar ratio of the total promoters and/or mixtures thereof present in the precious metal/iron oxide/support oxide composite to the precious metal based on the metallic elements is preferably in a range between 1:1 and 30:1; a range of between 2:1 and 15:1 is more preferred.

In addition to the required components of the catalyst according to the invention described above, all conceivable auxiliaries and/or additives can be used for production or further processing of the catalyst, such as for example oxides and mixed oxides as additives to the support material, binders, fillers, hydrocarbon adsorbers or other adsorbing materials, dopants for increasing the thermal stability and mixtures of at least two of the abovementioned substances.

The activity of the catalyst is also dependent in particular on the macroscopic form and morphology of the catalyst. With regard to the form of the catalyst, all embodiments which have already proven suitable in very general terms in catalyst research, i.e. in particular washcoat and/or honeycomb technologies, are preferred.

The abovementioned technologies are based on the majority of the support material being milled in aqueous suspension to particle sizes of a few micrometers and then being applied to a ceramic or metallic shaped body. In principle, further components in water-soluble or water-insoluble form can be introduced into the washcoat before or after the coating operation. After all the constituents of the catalyst have been applied to the shaped body, the latter is generally dried and calcined at elevated temperatures.

Arrangements of the support material with a high BET surface area and a high retention of the BET surface area after thermal ageing are particularly preferred.

With regard to the pore structure, macro-pores which have been fully formed in particular to form passages and which coexist with meso-pores and/or micro-pores are preferred. In this case, the meso-pores and/or the micro-pores contain the precious metal, in this case platinum and/or rhodium. As has been stated above, in the context of the present invention it is particularly preferable that

(aa) precious metal, iron oxide and if present promoters be jointly present in immediate topological proximity, and that

(bb) precious metal, iron oxide and, if present, promoter be distributed as homogeneously as possible, as a single unit, over the surface of the porous support material.

The choice of support oxide and of promoters is a crucial factor in determining whether the catalyst according to the invention can be used as a diesel oxidation catalyst or as a three-way catalyst.

If, for example, a composite of platinum, zirconium oxide, iron oxide and gallium oxide is used, the NOₓ conversion rates determined in rich/lean mode tend to be low, but the activity for the CO and HC conversion after thermal ageing is very high. A catalyst of this type is preferably used as a diesel oxidation catalyst.

However, if lanthanum oxide is used instead of the gallium oxide, the NOₓ activity is improved considerably, and consequently this catalyst can also be used as a three-way catalyst.

A ZrO₂ produced by Norton (Norton trade name “XZ 16075”) is particularly preferably used for the abovementioned examples. In principle, ZrO₂ can be produced by precipitation processes known to the person skilled in the art. In particular, vapour calcining of the material precipitated in this way leads to zirconium oxides which are preferred in the context of the invention. Alternatively, it is also possible for Ce/Zr mixed oxide to be used as support oxide for the precious metal and iron oxide. The preferred mass ratio of CeO₂ to ZrO₂ is in this case 1:1, more preferably 1:5, even more preferably 1:10.

Of course, it is also possible for a mixture of ZrO₂ and Ce/Zr mixed oxide to be used as support for the precious metal and iron oxide, in which case there are no limits with regard to the mass ratio of the two support oxides with respect to one another.

The discovery that a composite catalyst consisting of rhodium/iron oxide and γ-aluminium oxide is able to achieve significant NOₓ conversion rates, whereas a catalyst consisting of rhodium and γ-aluminium oxide has scarcely any NOₓ activity in cyclical lean/rich mode, is very surprising.

For some applications, it will be recommended for some of the precious metal to be deposited on a further support oxide, for example Al₂O₃, SiO₂ or SiO₂/Al₂O₃, since it is in this way possible to achieve targeted setting of the further functions of the catalyst, such as its ability to oxidize carbon monoxide and hydrocarbons. A composite of this type consisting of precious metal and support oxide could then either be applied to the honeycomb support as an additional active coating or could be admixed with the precious metal/iron oxide/support oxide, if appropriate together with further promoters as mentioned above, before the coating process.

In principle, any process with which the person skilled in the art is familiar for the production of catalysts, in particular of impregnated and surface-impregnated catalysts, can be used to homogeneously disperse the catalytically active substances, i.e. in particular to homogeneously disperse precious metals, iron oxide and promoters. In this context, mention should be made, for example, of the following methods, some of which are also described in the exemplary embodiments: impregnation of the support materials with metal salt solutions, adsorption of metal salts from gases or liquids on the support materials, application by precipitation from solutions, formation of layers and/or double layers, introduction of colloids, gels, nanoparticles, a spraying or deposition from solutions.

The catalyst according to the invention is preferably in the form of a powder, granules, extrudate, a shaped body or a coated honeycomb body.

The invention also relates to the use of the catalyst for removing pollutants from exhaust gases from lean-burn engines.

Furthermore, the present invention also relates to a method for purifying exhaust gases from lean-burn engines in rich/lean and constant lean mode, in each case using at least one catalyst as described above.

The method according to the invention for converting/detoxifying CO and HC in the context of diesel oxidation catalysis consists in the catalyst according to the invention being operated under constant lean exhaust-gas conditions.

The method according to the invention for converting/detoxifying the exhaust gases in accordance with the principle of a three-way catalyst as defined above consists in the catalyst according to the invention being operated in a rich/lean cycle. The time windows of the said rich/lean cycle are selected in such a way that the nitrogen oxide emissions are lowered by the catalyst during the lean-burn phase, and the catalyst is regenerated by briefly using richer conditions.

The said time window is given by two parameters, namely the duration of the lean phase and the ratio of lean phase to rich phase. In general, any choice of parameters which leads to sufficient integral nitrogen oxide conversion is permissible. The duration of the lean phase depends largely on the concentrations of the oxygen and the nitrogen oxides in the exhaust gas and on the total volumetric flow of the exhaust gas and the temperature at the catalyst. The duration of the rich phase is determined by the factors air/fuel ratio λ, the concentrations of H₂, CO in the exhaust gas and the total volumetric flow. A value of greater than 5:1 is preferred for the time ratio of lean phase to rich phase, with a value of greater than 10:1 being more preferred and a value of greater than 15:1 being particularly preferred. Any desired duration is conceivable for the duration of the lean phase, and for practical applications in normal driving mode a time window of from 5 to 240 seconds, in each case inclusive, is preferred, and a time window of from 10 to 80 seconds duration is particularly preferred.

In this context, it should also be noted that the method according to the invention, like any method for the regulated catalysis of exhaust gases, is or can be regulated not only by sensors and control codes, but also is influenced by the way in which the vehicle is driven. For example, “natural” richer operation occurs if the engine is accelerated to high revs and/or suddenly and/or is operated under high loads. In operating states of this type, driving operation can, for example, be temporarily switched over to non-lean operation with λ=1 or λ<1, or alternatively it is possible for the rich phase, for a short period of time, to last longer than in normal, regulated operation, or for the rich phase to be favoured for operational reasons.

In one preferred embodiment, an NOₓ sensor is used to control the rich/lean cycle, and a richer phase is in each case induced precisely when a predetermined NOₓ limit value is reached.

It should be noted that the use of iron oxide boosts the durability of the catalyst both for the oxidation of CO and HC to form CO₂ and water and for the oxidation of NO to form NO₂. Since the NO₂ formation at the active metal represents an important substep in the NOₓ storage at which is known as the “NOₓ storage catalyst”, the catalyst according to the invention, in combination with NOₓ-storing media, such as the alkali metal oxides, alkaline-earth metal oxides and the basic rare earth oxides, can serve as a highly efficient storage catalyst. The addition of alkali metals, alkaline-earth metals and the basic rare earth oxides allows the NOₓ storage capacity of the catalyst according to the invention to be increased significantly. In this case too, the terms alkali metal oxides, alkaline-earth metal oxides and basic rare earth oxide also encompass the corresponding carbonates, hydroxides and suboxides. The relationship between NO₂ formation at active metals, NO₂ formation and NOₓ storage elements is one with which the person skilled in the art is familiar and is described, for example, in the publication “Development of new concept three-way catalyst for automotive leanburn engines” SAE 950809 (1995) et al.

Another application for catalysts which promote the oxidation of NO to form NO₂ results from a combination with a particulate filter. For example, in what is known as the CRT (Continuously Regenerating Trap) system, a particulate filter is connected downstream of an oxidation catalyst. The oxidation catalyst forms NO₂, which represents a strong oxidizing agent, in a temperature window from approx. 200-450° C., and this oxidizing agent is able to oxidize and thereby breakdown the particulates which have collected on the particulate filter. It is desirable for the oxidation catalyst to be highly thermally stable, since otherwise the CRT activity decreases with progressive ageing of the oxidation catalyst. The way in which the CRT system functions is described in EP Patent 835 684.

With regard to the use of the catalyst according to the invention, it should be noted that it is preferable for the catalyst to be installed in a position close to the engine or to be installed in an underfloor position. The catalyst according to the invention may also be operated in combination with at least one further catalyst or filter selected from the following group: conventional starting or light-off catalysts, HC-SCR catalysts, NOₓ storage catalysts, λ-regulated three-way catalysts, soot or particulate filters. In this context, by way of example, the soot particulate filter may be coated with the catalyst according to the invention. It is conceivable for the catalyst according to the invention to be combined with the abovementioned catalysts (α) by sequential arrangement of the various catalysts, (β) by physical mixing of the various catalysts and application to a common shaped body, or (γ) by application of the various catalysts in the form of layers to a common shaped body, and of course in any desired combination of the above.

It is preferable for the method according to the invention to be carried out in such a manner that the exhaust-gas purification comprises the simultaneous oxidation of hydrocarbons and carbon monoxide and the reduction of nitrogen oxides, and also, optionally, in the case of diesel engines, the removal of particulates.

Furthermore, it should also be noted that the catalyst according to the invention can be used in virtually all conceivable lean-burn engines, in which context spark-ignition engines with direct petrol injection, hybrid engines, diesel engines, multi-fuel engines, stratified charge engines and spark-ignition engines with unthrottled part-load operation and higher compression or with unthrottled part-load operation or higher compression, each with direct injection, are preferred.

A preferred operating mode is also defined by the rich/lean mode being regulated using an NOₓ sensor, which is preferably fitted downstream of the final exhaust-gas catalyst, with richer operation being induced when an adjustable NOₓ threshold value is exceeded.

The production of examples of catalysts according to the invention, as well as their improved properties compared to the prior art, are to be illustrated and explained below in exemplary embodiments. The fact that this is done using specific examples giving specific numerical values should not in any way be regarded as restricting the general details given in the description and the claims.

In the Figures:

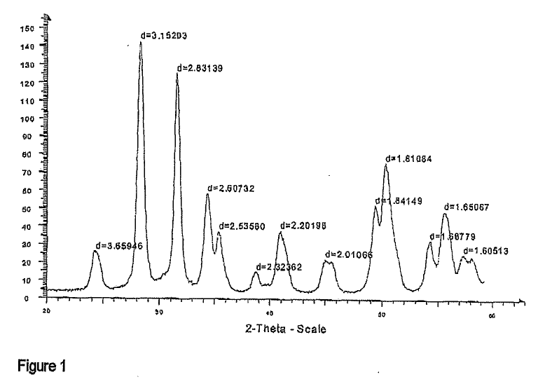

FIG. 1 shows an X-ray diffractogram of the support in accordance with Example 1.

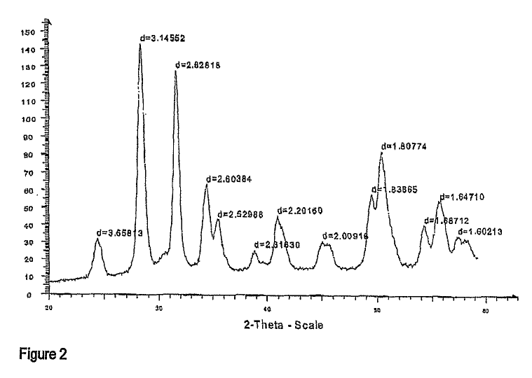

FIG. 2 shows an X-ray diffractogram for the fresh catalyst in accordance with Example 3.

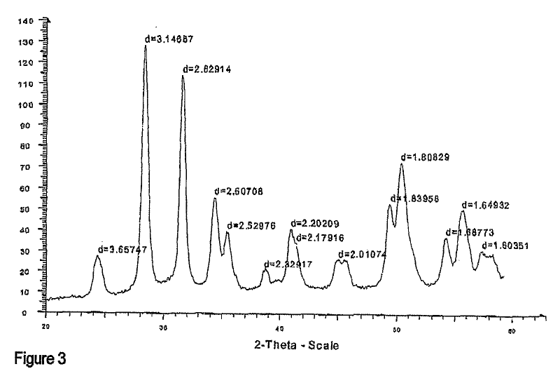

FIG. 3 shows an X-ray diffractogram for the aged catalyst in accordance with Example 3.

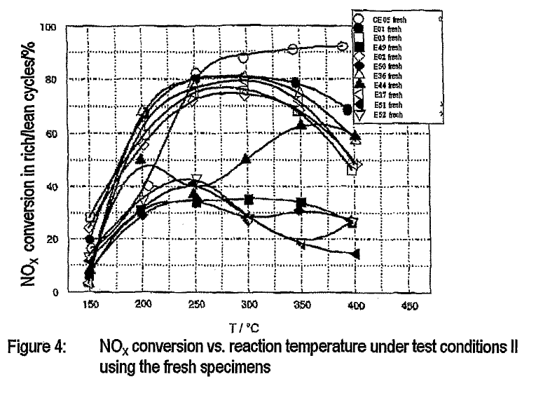

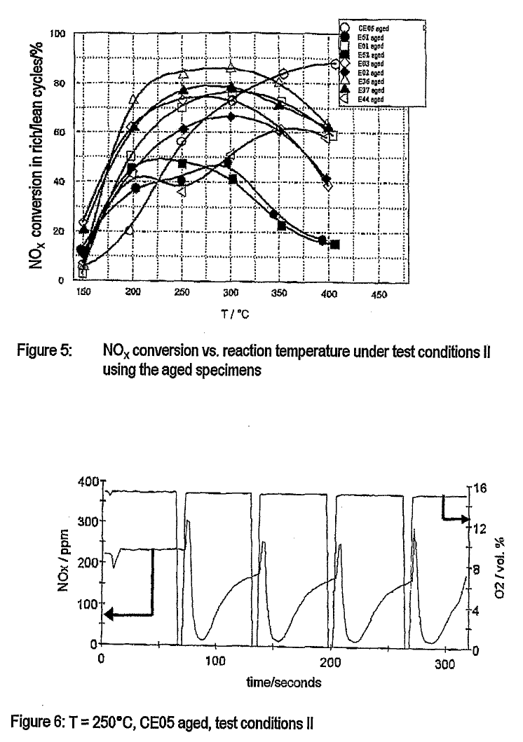

FIGS. 4 and 5 show the mean NOₓ conversion as a function of the reaction temperature under test conditions II at the fresh catalyst (FIG. 4) and aged catalyst (FIG. 5) listed in the figures.

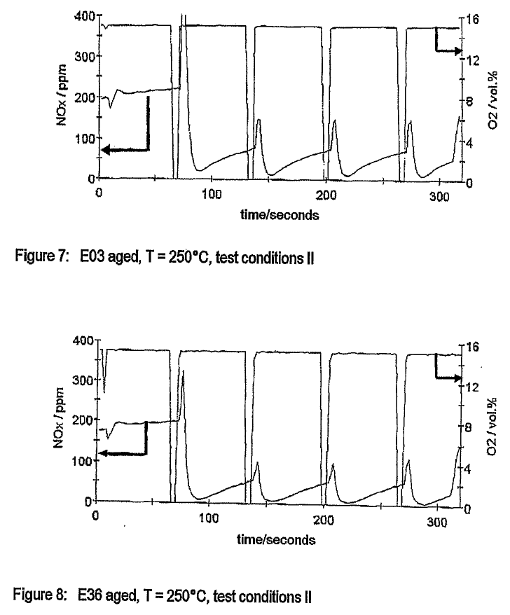

FIGS. 6 to 8 show the time curve for the NOₓ conversion at 250° C. at the aged catalysts in accordance with CE05 (FIG. 6), E03 (FIG. 7) and E37 (FIG. 8).

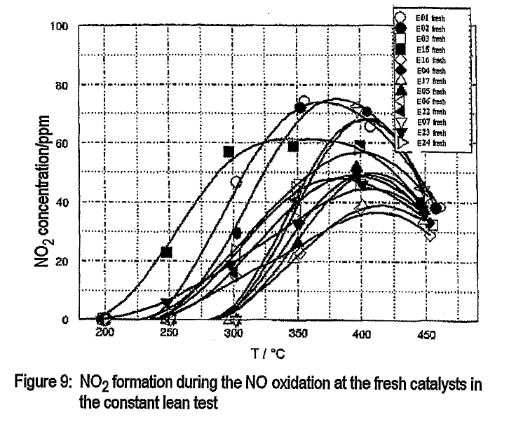

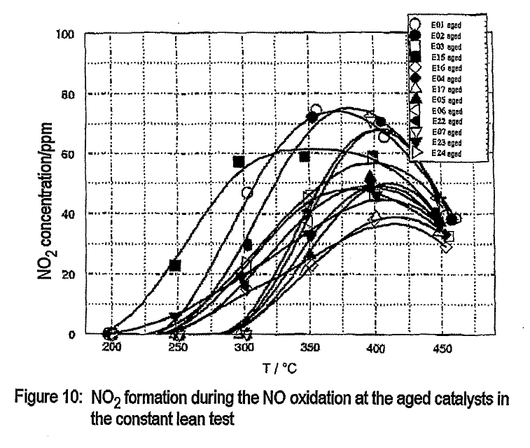

FIGS. 9 and 10 show the formation of NO₂ as a function of the reaction temperature for the fresh catalysts (FIG. 9) and aged catalysts (FIG. 10) indicated in these figures.

### EXAMPLES

### Example 1 (E1)

To produce a catalyst, 1 g of zirconium oxide (XZ16075) produced by Norton was provided as the initial support oxide. 26 μl of aqueous 1-molar platinum nitrate solution were mixed with 60 μl of 3-molar iron nitrate solution and diluted with 664 μl of water. The zirconium oxide was impregnated with 750 μl of the resulting solution, which corresponded to the water uptake of the zirconium oxide. The ZrO₂ which had been impregnated in this way was then dried for 16 hours at 80° C. Then, the material was calcined for 2 hours at 500° C. in air (referred to as “fresh”). Some of the fresh material was additionally calcined for 16 hours at 700° C. in air (referred to as “aged”).

### Examples 2 to 42 (E2-E42)

The catalysts were produced as described in Example 1, with the zirconium oxide being impregnated with aqueous solution of iron nitrate and further salts, such as platinum nitrate, rhodium nitrate, lanthanum nitrate, gallium nitrate, indium nitrate, samarium nitrate and cerium nitrate. Table 1 gives the compositions of the corresponding catalysts, based on percent by weight.

The BET surface area of the zirconium oxide is 46 m²/g in the untreated state. The majority of this support oxide is composed of the monoclinic form of the zirconium oxide. The phase composition of the support is illustrated in the X-ray diffractogram (BRUKER AXS with GADDS surface detector) shown in FIG. 1.

The phase compositions of the platinum/iron oxide/ZrO₂ catalysts stabilized with iron oxide revealed no significant changes compared to the ZrO₂ support material. The X-ray diffractograms of a fresh catalyst and an aged catalyst (Example 3) are illustrated in FIG. 2 (“fresh”) and FIG. 3 (“aged”). The X-ray diffractometer used was an appliance produced by Bruker, namely the BRUKER AXS with GADDS surface detector.

A comparison of FIG. 1 with FIGS. 2 and 3 makes it clear that the catalysts according to the invention do not have any reflections typical of iron oxide.

TABLE 1
Compositions of the precious metal/ZrO₂ catalysts stabilized with iron
oxide (E01-E44)

| | Sample | | | | | | | | | |
|---|---|---|---|---|---|---|---|---|---|---|
| | designation | | Content/% by weight | | | | | | | |
| Example | fresh | aged | Fe | Pt | Rh | La | Ga | In | Sm | Ce |
| E01 | D1763 | D1764 | 1 | 1 | | | | | | |
| E02 | D1765 | D1766 | 3 | 1 | | | | | | |
| E03 | D1767 | D1768 | 5 | 1 | | | | | | |
| E04 | D1769 | D1770 | 10 | 1 | | | | | | |
| E05 | D1771 | D1772 | 5 | 0.9 | 0.1 | | | | | |
| E06 | D1773 | D1774 | 5 | 0.8 | 0.2 | | | | | |
| E07 | D1775 | D1776 | 5 | 0.5 | 0.5 | | | | | |
| E08 | D1777 | D1778 | 1 | 1 | | 5 | | | | |
| E09 | D1779 | D1780 | 3 | 1 | | 5 | | | | |
| E10 | D1781 | D1782 | 5 | 1 | | 5 | | | | |
| E11 | D1783 | D1784 | 10 | 1 | | 5 | | | | |
| E12 | D1785 | D1786 | 5 | 0.9 | 0.1 | 5 | | | | |
| E13 | D1787 | D1788 | 5 | 0.8 | 0.2 | 5 | | | | |
| E14 | D1789 | D1790 | 5 | 0.5 | 0.5 | 5 | | | | |
| E15 | D1791 | D1792 | 1 | 1 | | | 5 | | | |
| E16 | D1793 | D1794 | 3 | 1 | | | 5 | | | |
| E17 | D1795 | D1796 | 5 | 1 | | | 5 | | | |
| E18 | D1797 | D1798 | 10 | 1 | | | 5 | | | |
| E19 | D1799 | D1800 | 5 | 0.9 | 0.1 | | 5 | | | |
| E20 | D1801 | D1802 | 5 | 0.8 | 0.2 | | 5 | | | |
| E21 | D1803 | D1804 | 5 | 0.5 | 0.5 | | 5 | | | |
| E22 | D1805 | D1806 | 1 | 1 | | | | 5 | | |
| E23 | D1807 | D1808 | 3 | 1 | | | | 5 | | |
| E24 | D1809 | D1810 | 5 | 1 | | | | 5 | | |
| E25 | D1811 | D1812 | 10 | 1 | | | | 5 | | |
| E26 | D1813 | D1814 | 5 | 0.9 | 0.1 | | | 5 | | |
| E27 | D1815 | D1816 | 5 | 0.8 | 0.2 | | | 5 | | |
| E28 | D1817 | D1818 | 5 | 0.5 | 0.5 | | | 5 | | |
| E29 | D1819 | D1820 | 1 | 1 | | | | | 5 | |
| E30 | D1821 | D1822 | 3 | 1 | | | | | 5 | |
| E31 | D1823 | D1824 | 5 | 1 | | | | | 5 | |
| E32 | D1825 | D1826 | 10 | 1 | | | | | 5 | |
| E33 | D1827 | D1828 | 5 | 0.9 | 0.1 | | | | 5 | |
| E34 | D1829 | D1830 | 5 | 0.8 | 0.2 | | | | 5 | |
| E35 | D1831 | D1832 | 5 | 0.5 | 0.5 | | | | 5 | |
| E36 | D1833 | D1834 | 1 | 1 | | | | | | 5 |
| E37 | D1835 | D1836 | 3 | 1 | | | | | | 5 |
| E38 | D1837 | D1838 | 5 | 1 | | | | | | 5 |
| E39 | D1839 | D1840 | 10 | 1 | | | | | | 5 |
| E40 | D1841 | D1842 | 5 | 0.9 | 0.1 | | | | | 5 |
| E41 | D1843 | D1844 | 5 | 0.8 | 0.2 | | | | | 5 |
| E42 | D1845 | D1846 | 5 | 0.5 | 0.5 | | | | | 5 |
| E43 | D1026 | D1027 | 1 | | 0.5 | | | | | |
| E44 | D1030 | D1031 | 2 | | 0.5 | | | | | |

### Example 45

To produce a catalyst, 1 g of aluminium oxide produced by Brace was provided as the initial support oxide. 49 μl of aqueous 1 molar rhodium nitrate solution were mixed with 72 μl of 2.5-molar iron nitrate solution and diluted with 1 029 μl of water. The aluminium oxide was impregnated with 1 150 μl of the resulting solution, corresponding to the water uptake of the aluminium oxide. The Al₂O₃ impregnated in this way was then dried at 80° C. for 16 hours. Then, the material was calcined for 2 hours at 500° C. in air (referred to as “fresh”). Some of the fresh material was additionally calcined for 16 hours at 700° C. in air (referred to as “aged”).

### Examples 46 to 48 (E46-E48)

The catalysts were produced analogously to Example 45, except that the aluminium oxide was laden with the different quantities of iron. Table 2 gives the compositions of the corresponding catalysts based on percent by weight.

### Examples 49 to 50 (E49-E50)

To produce a catalyst, 1 g of H-ZSM-5 zeolite as support material was placed into a 1-molar ammonium sulphate solution and stirred at 50° C. for one hour. Then, the zeolite support was removed using a centrifuge and the supernatant solution was decantered off. The stirring in ammonium sulphate solution was repeated two more times. Then, the zeolite support was washed with deionized water and dried. The resulting support material was mixed with iron(ll) oxalate and calcined in a muffle furnace for 16 hours under forming gas (5% of H₂ in N₂) at 600° C. Then, the iron-containing support was impregnated with rhodium nitrate, dried and calcined in air for 2 hours at 500° C.

### Example 51 (E51)

To produce a catalyst, 1 g of beta-zeolite was provided as the initial support. 49 μl of aqueous 1-molar rhodium nitrate solution were mixed with 72 μl of 2.5-molar iron nitrate solution and diluted with 1 779 μl of water. The aluminium oxide was impregnated with 1 900 μl of the resulting solution. The beta-zeolite impregnated in this way was then dried for 16 hours at 80° C. The material was then calcined for 2 hours at 500° C. in air.

### Example 52 (E52)

The catalysts were produced as described in Example 51, except that the rhodium loading was varied. Table 2 gives the compositions of the corresponding catalysts, based on percent by weight.

TABLE 2
Composition of the iron-oxide-stabilized precious metal/Al₂O₃ and
precious metal/zeolite catalysts (E45-E52)

| | | | | Content/% | |
|---|---|---|---|---|---|
| | Sample designation | | | by weight | |
| Example | fresh | aged | Support | Fe | Rh |
| E45 | D1074 | D1075 | Al₂O₃ | 1 | 0.5 |
| E46 | D1078 | D1079 | Al₂O₃ | 2 | 0.5 |
| E47 | D1082 | D1083 | Al₂O₃ | 3 | 0.5 |
| E48 | D1086 | D1087 | Al₂O₃ | 5 | 0.5 |
| E49 | D1693 | D1694 | ZSM-5 | 0.8 | 1 |
| E50 | D1697 | D1698 | ZSM-5 | 0.2 | 1 |
| E51 | P0100_066_REF005 | P0100_066_REF006 | Beta-zeolite | 0.5 | 0.25 |
| E52 | P0100_066_REF007 | P0100-066-REF008 | Beta-zeolite | 0.5 | 0.5 |

### Comparative Examples 1 to 4 (CE01-CE04)

Catalysts comprising Pt and Fe alone were produced by impregnation with the corresponding nitrate solutions

TABLE 3
Composition of the Pt- and Fe-containing ZrO₂ catalysts (CE01-CE04)

| | | | Content/% | |
|---|---|---|---|---|
| | Sample designation | | by weight | |
| Example | fresh | aged | Fe | Pt |
| CE01 | P0100_052_IMP001 | P0100_052_IMP002 | | 0.5 |
| CE02 | P0100_052_IMP004 | P0100_052_IMP005 | | 1 |
| CE03 | D1132 | D1133 | 3 | |
| CE04 | D1144 | D1145 | 10 | |

### Comparative Example 5 (CE05)

Comparative Example 5 includes a commercially available NOₓ storage catalyst based on Pt/Ba/Ce (reference catalyst).

Catalyst Testing

Activity measurements were carried out in fixed-bed laboratory reactors made from stainless steel under simulated exhaust gas. The catalysts were tested in cyclical rich/lean mode and in continuous operation with excess oxygen in the temperature range between 150 and 450° C.
Rich/lean test conditions I
Rich/lean settings: 2 s rich/80 s lean
Gas mixture composition
   Lean: 1 000 vppm CO, 100 vppm propene, 300 vvpm NO, 6% O₂, 5% H₂O, remainder—N₂
   Rich: 0.03% O₂, ˜6% CO, ˜2% H₂
Gas throughput: 45 L/h
Catalyst mass used for the testing: 0.25 g
Rich/lean test conditions II
Rich/lean settings: 5 s rich/60 s lean
Gas mixture composition
   Lean: 500 vppm CO, 100 vppm propene, 200 vppm NO, 14% O₂, 10% H₂O, remainder—N₂
   Rich: 0.03% O₂, ˜6% CO, ˜2% H₂
Gas throughput: 32 L/h
Catalyst mass used for the testing: 0.25 g
Constant lean test conditions
Gas mixture composition: 1 000 vppm CO, 100 vppm propene, 300 vppm NO, 6% O₂, 5% H₂O, remainder—N₂
Gas throughput: 45 L/h
Catalyst mass used for the testing: 0.25 g

To evaluate the catalysts, the mean NOₓ conversions within three rich/lean cycles at different reaction temperatures were determined. Furthermore, the T₅₀ values (temperature at which 50% conversion is reached) for the CO and propene oxidation and the NO₂ formation for the NO oxidation in the constant lean test were used to evaluate the oxidation activity. The catalysts were compared with one another and with the reference catalyst based on identical quantities of precious metals.

The results of the catalytic tests on the NOₓ conversion under test conditions I are compiled in Tables 4 (fresh specimens) and 5 (aged specimens). The mean NOₓ conversion as a function of the reaction temperature under test conditions II at the selected catalysts is illustrated in FIGS. 4 and 5. The time curve of the NOₓ conversion at 250° C. at 3 aged specimens (CE05, E03 and E36) is illustrated in FIGS. 6 to 8.

The T50 values in constant lean mode at the fresh and aged catalysts are given in Table 6. The NO₂ formation as a function of the reaction temperature for the fresh and aged specimens is illustrated in FIGS. 9 and 10.

It can be seen from the results that the new catalysts, after thermal ageing in particular in the temperature range from 200-300° C. which is of importance for diesel applications, allow significantly higher NOₓ conversion rates than the reference catalyst.

TABLE 4
Results of the catalytic tests on NOₓ conversion in rich/lean mode on the
fresh catalysts (test conditions I)

Mean NOₓ conversion in 3 rich/lean cycles/%

| Example | 200° C. | 250° C. | 300° C. | 400° C. |
|---|---|---|---|---|
| E01 | 17 | 58 | 67 | 37 |
| E02 | 35 | 52 | 58 | 32 |
| E03 | 37 | 52 | 57 | 26 |
| E04 | 32 | 46 | 46 | 19 |
| E05 | 36 | 51 | 56 | 28 |
| E06 | 33 | 47 | 51 | 31 |
| E07 | 28 | 42 | 48 | 33 |
| E08 | 13 | 65 | 80 | 66 |
| E09 | 6 | 51 | 61 | 55 |
| E10 | 20 | 50 | 60 | 50 |
| E11 | 23 | 45 | 56 | 41 |
| E12 | 18 | 46 | 54 | 46 |
| E13 | 34 | 47 | 52 | 46 |
| E14 | 0 | 39 | 48 | 45 |
| E15 | 35 | 53 | 47 | 18 |
| E16 | 0 | 45 | 42 | 14 |
| E17 | 28 | 40 | 39 | 14 |
| E18 | 0 | 37 | 35 | 13 |
| E19 | 31 | 40 | 37 | 16 |
| E20 | 0 | 40 | 35 | 14 |
| E21 | 27 | 34 | 33 | 17 |
| E22 | 0 | 39 | 38 | 26 |
| E23 | 40 | 38 | 39 | 21 |
| E24 | 41 | 41 | 37 | 18 |
| E25 | 0 | 28 | 33 | 15 |
| E26 | 27 | 36 | 37 | 19 |
| E27 | 30 | 38 | 36 | 19 |
| E28 | 25 | 35 | 34 | 20 |
| E29 | 16 | 60 | 66 | 54 |
| E30 | 0 | 46 | 56 | 45 |
| E31 | 16 | 45 | 51 | 36 |
| E32 | 0 | 39 | 46 | 33 |
| E33 | 31 | 46 | 51 | 38 |
| E34 | 36 | 45 | 50 | 39 |
| E35 | 4 | 35 | 39 | 39 |
| E36 | 35 | 57 | 63 | 32 |
| E37 | 22 | 47 | 54 | 25 |
| E38 | 22 | 38 | 46 | 17 |
| E39 | 6 | 28 | 37 | 15 |
| E40 | 24 | 39 | 42 | 20 |
| E41 | 10 | 37 | 44 | 16 |
| E42 | 9 | 30 | 37 | 16 |
| E43 | 6 | 32 | 53 | 65 |
| E44 | 17 | 29 | 47 | 55 |
| E45 | 7 | 22 | 37 | 66 |
| E46 | 6 | 22 | 37 | 57 |
| E47 | 7 | 22 | 35 | 50 |
| E48 | 6 | 22 | 32 | 43 |
| E49 | 14 | 21 | 18 | 11 |
| E50 | 17 | 20 | 15 | 12 |
| E51 | 12 | 26 | 18 | 0 |
| E52 | 15 | 30 | 16 | 18 |
| CE01 | 0.4 | 17 | 19 | 52 |
| CE02 | 27 | 31 | 27 | 8 |
| CE03 | 0 | 0 | 1 | 4 |
| CE04 | 0 | 0 | 1 | 3 |
| CE05 | 41 | 71 | 86 | 90 |

TABLE 5
Results of the catalytic tests on NOₓ conversion in rich/lean mode on the
aged catalysts (test conditions I)

Mean NOₓ conversion in 3 rich/lean cycles/%

| Example | 200° C. | 250° C. | 300° C. | 400° C. |
|---|---|---|---|---|
| E01 | 4 | 35 | 51 | 32 |
| E02 | 12 | 42 | 49 | 24 |
| E03 | 22 | 43 | 45 | 21 |
| E04 | 21 | 39 | 41 | 19 |
| E05 | 26 | 38 | 40 | 20 |
| E06 | 24 | 33 | 37 | 22 |
| E07 | 23 | 30 | 38 | 23 |
| E08 | 7 | 48 | 73 | 62 |
| E09 | 0 | 5 | 43 | 50 |
| E10 | 2 | 23 | 43 | 40 |
| E11 | 0 | 9 | 28 | 33 |
| E12 | 1 | 17 | 34 | 38 |
| E13 | 4 | 17 | 33 | 38 |
| E14 | 0 | 15 | 35 | 35 |
| E15 | 2 | 18 | 25 | 8 |
| E16 | 3 | 19 | 22 | 5 |
| E17 | 3 | 18 | 21 | 5 |
| E18 | 2 | 16 | 19 | 4 |
| E19 | 6 | 17 | 22 | 7 |
| E20 | 6 | 16 | 19 | 5 |
| E21 | 1 | 8 | 13 | 7 |
| E22 | 1 | 9 | 13 | 19 |
| E23 | 14 | 12 | 17 | 13 |
| E24 | 15 | 18 | 21 | 13 |
| E25 | 1 | 10 | 19 | 17 |
| E26 | 0 | 31 | 32 | 17 |
| E27 | 0 | 31 | 31 | 18 |
| E28 | 0 | 24 | 30 | 21 |
| E29 | 3 | 30 | 59 | 54 |
| E30 | 8 | 31 | 47 | 45 |
| E31 | 19 | 31 | 46 | 39 |
| E32 | 15 | 31 | 44 | 34 |
| E33 | 0 | 31 | 43 | 34 |
| E34 | 1 | 33 | 44 | 33 |
| E35 | 0 | 3 | 24 | 28 |
| E36 | 31 | 46 | 56 | 39 |
| E37 | 24 | 44 | 50 | 31 |
| E38 | 26 | 41 | 48 | 27 |
| E39 | 14 | 30 | 39 | 22 |
| E40 | 2 | 26 | 38 | 20 |
| E41 | 1 | 21 | 33 | 17 |
| E42 | 1 | 19 | 31 | 18 |
| E43 | 1 | 18 | 39 | 51 |
| E44 | 1 | 19 | 43 | 43 |
| CE01 | 2 | 16 | 22 | 18 |
| CE02 | 0.6 | 16 | 23 | 24 |
| CE03 | 0 | 0 | 0.7 | 3 |
| CE04 | 0 | 0 | 0.1 | 1 |
| CE05 | 19 | 43 | 58 | 78 |

TABLE 6
Results of the catalytic tests on CO and HC oxidation

| | |
|---|---|
| T₅₀ values-CO [° C.] | T₅₀ values-HC [° C.] |

| Example | fresh | aged | fresh | aged |
|---|---|---|---|---|
| E01 | 193 | 217 | 232 | 228 |
| E02 | 165 | 166 | 174 | 217 |
| E03 | 155 | 165 | 194 | 216 |
| E04 | 165 | 165 | 204 | 216 |
| E05 | 165 | 165 | 215 | 215 |
| E06 | 165 | 165 | 206 | 214 |
| E07 | 165 | 165 | 206 | 215 |
| E08 | 165 | 225 | 215 | 225 |
| E09 | 219 | 220 | 219 | 191 |
| E10 | 168 | 167 | 213 | 187 |
| E11 | 211 | 182 | 210 | 182 |
| E12 | 198 | 187 | 213 | 177 |
| E13 | 203 | 163 | 202 | 173 |
| E14 | 230 | 207 | 214 | 166 |
| E15 | 177 | 163 | 202 | 163 |
| E16 | 187 | 166 | 214 | 166 |
| E17 | 197 | 163 | 211 | 163 |
| E18 | 220 | 165 | 213 | 175 |
| E19 | 205 | 164 | 211 | 164 |
| E20 | <200 | 165 | 205 | 165 |
| E21 | <200 | 194 | 211 | 164 |
| E26 | <200 | <200 | 201 | 215 |
| E27 | <200 | <200 | 210 | 214 |
| E33 | <200 | 214 | 210 | 222 |
| E34 | <200 | 221 | 180 | 221 |
| E36 | 164 | 159 | 177 | 175 |
| E37 | 176 | 156 | 182 | 188 |
| E40 | 174 | 196 | 204 | 216 |
| E41 | 184 | 226 | 214 | 226 |
| E42 | 204 | 225 | 214 | 225 |
| CE01 | 216 | 217 | 216 | 217 |
| CE02 | 182 | 226 | 208 | 226 |
| CE03 | 284 | 279 | 323 | 328 |
| CE04 | 290 | 279 | 345 | 421 |
| CE07 | 165 | <200 | 165 | <200 |

1-20. (canceled)

21. A catalyst for exhaust-gas purification in lean-burn engines, comprising:
(i) iron oxide;
(ii) platinum or rhodium or a mixture of platinum and rhodium as active metal; and
(iii) a support oxide containing zirconium oxide, cerium/zirconium mixed oxide or mixtures of these compounds if the active metal used is platinum alone, or the support oxide containing zirconium oxide, cerium/zirconium mixed oxide, aluminium oxide, aluminosilicate, silicon oxide, zeolite or mixtures of these compounds if the active metal used is rhodium or a mixture of platinum and rhodium.

22. A catalyst according to claim 21, further comprising a promoter selected from the group consisting of rare earth oxide, gallium oxide or indium oxide or mixtures of these compounds.

23. A catalyst according to claim 22, wherein the iron oxide, the active metal and, if present, the promoter are jointly present on the support oxide.

24. A catalyst according to claim 21, wherein its X-ray diffractogram does not have any reflections which are characteristic of the iron oxide.

25. A catalyst according to claim 21 wherein the mass ratio, based on the metal elements, of the total iron oxide relative to the total active metal is in a range from 1:1 to 10:1.

26. A catalyst according to claim 21 wherein the total active metal forms a proportion of 0.1% by weight to 5% by weight relative to the total support oxide.

27. A catalyst according to claim 22 wherein the rare earth oxide is selected from the group consisting of La, Ce, Pr, Nd, Sm, Eu, Gd, Tb, Dy, Ho, Er, Tm, Yb, Lu oxide and mixtures or mixed oxides thereof.

28. A catalyst according to claim 21 wherein the mass ratio, based on the metal elements, of the total promoter relative to the total active metal is in a range from 1:1 to 20:1.

29. A catalyst according to claim 21 in the form of a powder, granules, an extrudate, a shaped body or a coated honeycomb body.

30. A catalyst according to claim 21 further comprising a NOₓ storage component.

31. A catalyst according to claim 30, wherein the NOₓ storage component is selected from the group consisting of oxides or carbonates of Ba, Sr, La, Pr, Nd, Sm, Eu, Gd, Tb, Dy, Ho, Er, Tm, Yb, Lu, on a porous support oxide.

32. A process for producing a catalyst according to claims 1, comprising the step of bringing the iron oxide (i) or an iron compound from which the said iron oxide is formed as a result of a heat treatment into contact with the active metal (ii) and the support oxide (iii).

33. Use of a catalyst according to claim 21 or a catalyst produced according to claim 32 for removing pollutants from exhaust gases from lean-burn engines.

34. A method for purifying the exhaust gas from lean-burn engines in the rich/lean and/or constant lean mode, wherein a catalyst according to one of claims 21 or a catalyst produced according to claim 32 is used.

35. A method according to claim 34, wherein the rich/lean mode is realized in alternating rich and lean cycles, with the ratio of the duration of lean cycles to the duration of rich cycles, in normal driving mode, being at least 10:1, and the absolute duration of a lean cycle in normal driving mode being from 10 seconds to 180 seconds.

36. A method according to claim 34, wherein the exhaust-gas purification comprises the oxidation of hydrocarbons and carbon monoxide and the reduction of nitrogen oxides, and optionally also, in the case of diesel engines, the removal of particulates.

37. A method according to claim 34, wherein the lean-burn engine is selected from the group consisting of spark-ignition engines with direct petrol injection, hybrid engines, diesel engines, multi-fuel engines, stratified charged engines and spark-ignition engines with unthrottled part-load operation and higher compression or with unthrottled part-load operation or higher compression, each with direct injection.

38. A method according to claim 34, wherein the catalyst is installed in a position close to the engine or in an underfloor position.

39. A method according to claim 34, wherein a NOₓ sensor is used to control the rich/lean cycle, and a richer phase is induced precisely when a predetermined NOₓ limit value is exceeded.

40. A method according to claim 34, wherein the catalyst is used in combination with at least one of the catalysts or filters selected from the following group: starting catalyst, HC-SCR catalyst, NOₓ storage catalyst, λ-controlled three-way catalyst, particulate filter, soot filter.
